(19) United States
(12) Patent Application Publication
(10) Pub. No.: US 2011/0141638 A1
(43) Pub. Date: Jun. 16, 2011

(54) ELECTROSTATIC PROTECTION DEVICE AND ELECTRONIC APPARATUS EQUIPPED THEREWITH

(75) Inventors: Yousuke HOSHIKAWA, Tokyo (JP); Mikio TSURUOKA, Tokyo (JP); Hiroyuki SATO, Tokyo (JP); Goro TAKEUCHI, Tokyo (JP); Dai MATSUOKA, Tokyo (JP)

(73) Assignee: TDK CORPORATION, Tokyo (JP)

(21) Appl. No.: 12/965,103

(22) Filed: Dec. 10, 2010

(30) Foreign Application Priority Data
Dec. 15, 2009 (JP) P2009-284101
Oct. 25, 2010 (JP) P2010-238888

(51) Int. Cl. H02H 9/04

(52) U.S. Cl. 361/56

(57) ABSTRACT

The electrostatic protection device in accordance with the present invention is the electrostatic protection device for protecting a plurality of electronic elements electrically connected in series against static electricity, the device comprising a plurality of first electrostatic protection elements having a current-voltage nonlinear resistance characteristic, a plurality of second electrostatic protection elements having a current-voltage nonlinear resistance characteristic, and a ground terminal for electrically connecting with a ground. The plurality of first electrostatic protection elements are electrically connected in parallel to the respective electronic elements, while the plurality of second electrostatic protection elements are electrically connected between input terminals of the respective electronic elements and the ground terminal.

### BACKGROUND OF THE INVENTION

1. Field of the Invention

The present invention relates to an electrostatic protection device and an electronic apparatus equipped therewith.

2. Related Background Art

Elements having current-voltage nonlinear resistance characteristics such as varistor elements have been in use as electrostatic protection devices which prevent the electrostatic breakdown of semiconductor elements and the like. For example, Japanese Patent Application Laid-Open No. 2001-15815 and Japanese Patent Application Laid-Open No. 2006-339559 disclose light-emitting diode (LED) elements to which varistor elements as electrostatic protection devices are connected. The varistor elements described in these literatures (Japanese Patent Application Laid-Open No. 2001-15815 and Japanese Patent Application Laid-Open No. 2006-339559) are electrically connected in parallel to an LED element. Therefore, when static electricity is applied to an input terminal of the LED element, most of the static electricity flows through the varistor elements, whereby the electrostatic breakdown of the LED element is suppressed.

### SUMMARY OF THE INVENTION

In some instances, a plurality of electronic elements are used while being electrically connected in series. For example, there are cases where a plurality of LED elements electrically connected in series are used for the backlight of a liquid crystal display, illumination, and the like.

When constructing an electrostatic protection device for such a plurality of electronic elements electrically connected in series by using varistor elements, the varistor elements may be electrically connected in parallel to the respective electronic devices connected in series as described in the above-mentioned Japanese Patent Application Laid-Open No. 2001-15815 and Japanese Patent Application Laid-Open No. 2006-339559.

However, the electrostatic breakdown suppression effect of each varistor element is not always perfect, whereby there are cases where the electrostatic protection device constructed as mentioned above fails to fully improve the electrostatic discharge withstand voltage of the plurality of electronic elements connected in series.

In the electrostatic protection device constructed as mentioned above, static electricity flowing into one electronic element and/or a varistor element connected in parallel thereto sequentially flows into adjacent electronic elements and/or varistor elements connected in parallel thereto. This has caused a problem that, when the electrostatic discharge withstand voltage varies among a plurality of electronic elements connected in series, the overall electrostatic discharge withstand voltage is substantially determined by the electronic element having the lowest electrostatic discharge withstand voltage and thus becomes lower.

In the electrostatic protection device constructed as mentioned above, static electricity may be applied to not only a terminal of the electronic element closest to an end part in the plurality of electronic elements connected in series but also terminals between two adjacent electronic elements, i.e., terminals of electronic elements in an intermediate part among the plurality of electronic elements connected in series. Such static electricity also flows through an electronic element in the intermediate part and/or a varistor element connected in parallel thereto and then sequentially into adjacent electronic elements and/or varistor elements connected in parallel thereto. As a consequence, there have been cases where the electrostatic discharge withstand voltage for the static electricity applied to terminals of electronic elements in the intermediate part cannot fully be improved.

For such reasons, the electrostatic discharge withstand voltage of a plurality of electronic elements electrically connected in series has been hard to be fully improved by an electrostatic protection device constructed by electrically connecting varistor elements in parallel to the respective electronic elements.

In view of such problems, it is an object of the present invention to provide an electrostatic protection device which can fully improve the electrostatic discharge withstand voltage of a plurality of electronic elements electrically connected in series and an electronic apparatus equipped therewith.

The electrostatic protection device in accordance with the present invention is an electrostatic protection device for protecting a plurality of electronic elements electrically connected in series against static electricity; the device comprising a plurality of first electrostatic protection elements having a current-voltage nonlinear resistance characteristic, a plurality of second electrostatic protection elements having a current-voltage nonlinear resistance characteristic, and a ground terminal for electrically connecting with a ground; wherein the plurality of first electrostatic protection elements are electrically connected in parallel to the respective electronic elements; and wherein the plurality of second electrostatic protection elements are electrically connected between input terminals of the respective electronic elements and the ground terminal.

In the electrostatic protection device in accordance with the present invention, static electricity fed into an input terminal of any electronic element flows into not only the first electrostatic protection element electrically connected in parallel thereto but also the second electrostatic protection element connected between the input terminal of the electronic element and the ground terminal. This improves the electrostatic discharge withstand voltage more than in the case where the electrostatic protection device is constructed by the first electrostatic protection elements alone.

In the electrostatic protection device in accordance with the present invention, the static electricity flowing into the second electrostatic protection element connected to one electronic element leads to the ground, whereby the part of static electricity directed to another electronic element adjacent to the former electronic element can be reduced. Therefore, even when the electrostatic discharge withstand voltage varies among a plurality of electronic elements connected in series, the influence of the electronic element having the lowest electrostatic discharge withstand voltage upon the overall electrostatic discharge withstand voltage decreases. This can inhibit the electronic element having the lowest electrostatic discharge withstand voltage from lowering the overall electrostatic discharge withstand voltage.

Part or whole of the static electricity applied to an input terminal of an electronic element in an intermediate part is guided through the second electrostatic protection element to the ground. Therefore, in the static electricity applied to the input terminal of the electronic element in the intermediate part, the part directed to other electronic elements decreases, thereby improving the electrostatic discharge withstand voltage for the static electricity applied to the input terminal of the electronic element in the intermediate part.

As a result of the foregoing, the electrostatic protection device in accordance with the present invention can fully improve the electrostatic discharge withstand voltage of a plurality of electronic elements electrically connected in series.

Preferably, the electrostatic protection device in accordance with the present invention further comprises a plurality of third electrostatic protection elements having a current-voltage nonlinear resistance characteristic, while the plurality of third electrostatic protection elements are electrically connected between output terminals of the respective electronic elements and the ground terminal.

This allows the third electrostatic protection elements to guide part or whole of the static electricity applied to the output terminals of the electronic elements to the ground. Therefore, the electrostatic discharge withstand voltage of the plurality of electronic elements electrically connected in series further improves.

Preferably, in the electrostatic protection device in accordance with the present invention, each of the plurality of first electrostatic protection elements and plurality of second electrostatic protection elements is a varistor element. This lets a plurality of varistor elements construct the electrostatic protection device in accordance with the present invention.

Preferably, in the electrostatic protection device in accordance with the present invention, each of the plurality of third electrostatic protection elements is a varistor element. This lets a plurality of varistor elements construct the electrostatic protection device in accordance with the present invention.

The electronic apparatus in accordance with the present invention comprises a plurality of electronic elements electrically connected in series and the electrostatic protection device in accordance with the present invention. This yields an electronic apparatus having a high electrostatic discharge withstand voltage.

The present invention provides an electrostatic protection device which can fully improve the electrostatic discharge withstand voltage of a plurality of electronic elements electrically connected in series and an electronic apparatus equipped therewith.

### BRIEF DESCRIPTION OF THE DRAWINGS

FIG. 1 is a diagram illustrating the circuit structure of the electrostatic protection device in accordance with a first embodiment and an electronic apparatus equipped therewith;

FIG. 2 is a plan view illustrating the structure of the electronic apparatus in accordance with the first embodiment;

FIG. 3 is a view illustrating a cross section taken along the line III-III of an electrostatic protection element group in FIG. 2;

FIG. 4 is a plan view illustrating the structure of the electronic apparatus in accordance with a second embodiment;

FIG. 5 is a diagram illustrating the circuit structure of the electronic apparatus in accordance with the second embodiment;

FIG. 6 is a diagram illustrating the circuit structure of the electrostatic protection device in accordance with a third embodiment and an electronic apparatus equipped therewith;

FIG. 7A is a diagram illustrating the circuit structure of the electronic apparatus in accordance with Comparative Examples 1;

FIG. 7B is a diagram illustrating the circuit structures of the electronic apparatus in accordance with Comparative Examples 2;

FIG. 7C is a diagram illustrating the circuit structures of the electronic apparatus in accordance with Comparative Examples 3;

FIG. 7D is a diagram illustrating the circuit structures of the electronic apparatus in accordance with Example 1;

FIG. 8 is a graph illustrating output voltage levels of a testing apparatus at which LED elements in the respective electronic apparatus in accordance with Comparative Examples 1 to 3 and Example 1 were destroyed;

FIG. 9A is a diagram illustrating structure of circuits of electronic apparatus;

FIG. 9B is a diagram illustrating structure of circuits of electronic apparatus;

FIG. 9C is a diagram illustrating structure of circuits of electronic apparatus;

FIG. 9D is a diagram illustrating structure of circuits of electronic apparatus; and

FIG. 10 is a chart listing overall resistance values of circuits and calculated values of a current I′ flowing through a resistance R2x.

### DESCRIPTION OF THE PREFERRED EMBODIMENTS

In the following, electrostatic protection devices in accordance with embodiments and electronic apparatus equipped therewith will be explained in detail with reference to the accompanying drawings. In the drawings, the same constituents will be referred to with the same signs when possible. Dimensional ratios within and among constituents in the drawings are arbitrary for easier viewing of the drawings.

### First Embodiment

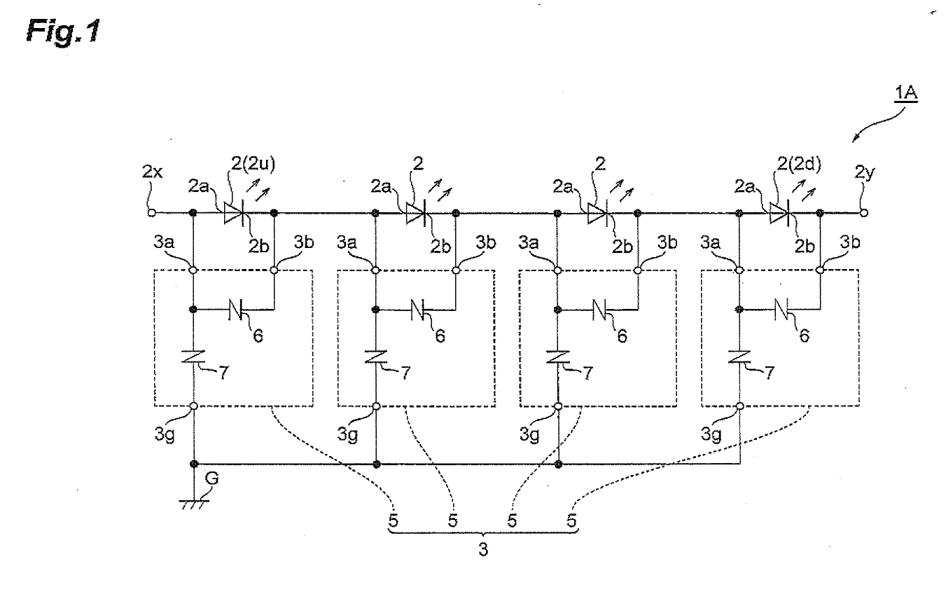

To begin with, the electrostatic protection device in accordance with the first embodiment and an electronic apparatus equipped therewith will be explained. FIG. 1 is a diagram illustrating the circuit structure of the electrostatic protection device in accordance with the first embodiment and the electronic apparatus equipped therewith.

As illustrated in FIG. 1, the electronic apparatus 1A in accordance with this embodiment comprises a plurality of electronic elements 2 and an electrostatic protection device 3.

In this embodiment, each of the plurality of electronic elements 2 is a light-emitting diode (LED) element. The plurality of electronic elements 2 are electrically connected in series. That is, in the plurality of electronic elements 2, an output terminal 2b of one of two adjacent electronic elements 2 and an input terminal 2a of the other are electrically connected to each other. In the plurality of electronic elements 2, the input terminal 2a of the electronic element 2u closest to one end part and the output terminal 2b of the electronic element 2d closest to the other end part are electrically connected to overall input and output terminals 2x, 2y for the plurality of electronic elements 2, respectively. A voltage for operating and driving the plurality of electronic elements 2 is applied between the input and output terminals 2x, 2y. The number of electronic elements 2 is 4 in this embodiment, but not limited in particular as long as it is plural.

The electronic element 2 may also be any of laser diode (LD), field-effect transistor (FET), and bipolar transistor elements and the like instead of the LED element.

The electrostatic protection device 3 is a device for protecting a plurality of electronic elements 2 against static electricity. As illustrated in FIG. 1, the electrostatic protection device 3 has a plurality of electrostatic protection element groups 5. The plurality of electrostatic protection element groups 5 have the same number as that of the plurality of electronic elements 2 and correspond one by one to the plurality of electronic elements 2.

Each of the plurality of electrostatic protection element groups 5 has a first electrostatic protection element 6 and a second electrostatic protection element 7. Each of the first and second electrostatic protection elements 6, 7 has a current-voltage nonlinear resistance characteristic (a characteristic in which the resistance value changes nonlinearly in response to the applied voltage). Specifically, each of the first and second electrostatic protection elements 6, 7 has such a characteristic that the resistance value decreases as the applied voltage increases within a certain applied voltage range.

As illustrated in FIG. 1, each of the first and second electrostatic protection elements 6, 7 is a varistor element in this embodiment. The varistor element drastically lowers its resistance value when a voltage at a voltage level known as varistor voltage or higher is applied thereto. As the varistor element in this embodiment, a ceramic varistor or gap varistor can be used, for example.

The first and second electrostatic protection elements 6, 7 may also be other elements having a current-voltage nonlinear resistance characteristic such as Zener diodes.

As illustrated in FIG. 1, each first electrostatic protection element 6 is electrically connected in parallel to its corresponding electronic element 2. Specifically, each first electrostatic protection element 6 is electrically connected between first and second terminals 3a, 3b of its corresponding electrostatic protection element group 5, while the first and second terminals 3a, 3b are electrically connected to the input and output terminals 2a, 2b of the electronic element 2, respectively.

Each second electrostatic protection element 7 is electrically connected between the input terminal 2a of its corresponding electronic element 2 and the ground G. Specifically, each second electrostatic protection element 7 is electrically connected between the first terminal 3a of its corresponding electrostatic protection element group 5 and a ground terminal 3g of the electrostatic protection element group 5. Each ground terminal 3g is electrically connected to the ground G.

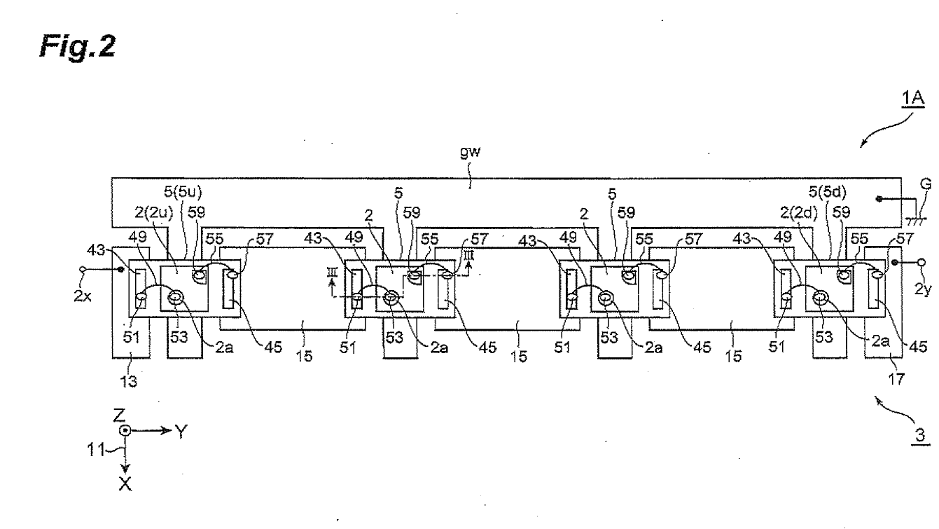

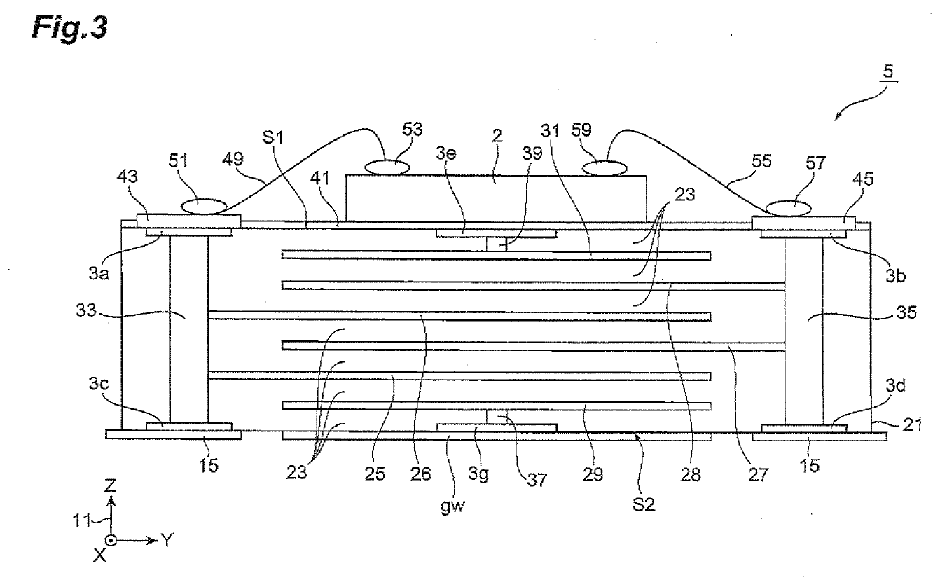

FIG. 2 is a plan view illustrating the structure of the electronic apparatus in accordance with this embodiment, while FIG. 3 is a view illustrating a cross section taken along the line III-III of an electrostatic protection element group in FIG. 2. FIGS. 2 and 3 show an orthogonal coordinate system 11.

As illustrated in FIG. 2, the plurality of electrostatic protection element groups 5 are disposed so as to be separated from each other along the Y-axis in the electronic apparatus 1A. In the plurality of electrostatic protection element groups 5, the electrostatic protection element group 5u located on the most negative side of the Y-axis is disposed on an input-terminal-side wiring layer 13, a ground wiring layer gw, and an intermediate wiring layer 15 as seen from the Z-axis. Each of the input-terminal-side wiring layer 13, ground wiring layer gw, and intermediate wiring layer 15 is a layer made of an electrically conductive material such as Ni, Cu, Ag, or Au extending along an XY plane with a thickness oriented in the Z-axis. The input-terminal-side wiring layer 13 is electrically connected to the input terminal 2x, while the ground wiring layer gw is electrically connected to the ground G.

On the other hand, the electrostatic protection element group 5d located on the most positive side of the Y-axis in the plurality of electrostatic protection element groups 5 is disposed on an intermediate wiring layer 15, the ground wiring layer gw, and an output-terminal-side wiring layer 17 as seen from the Z-axis. The output-terminal-side wiring layer 17 is electrically connected to the output terminal 2y.

In the plurality of electrostatic protection element groups 5, the electrostatic protection element groups 5 other than the electrostatic protection element groups 5u, 5d are each disposed on two intermediate layers 15 and the ground wiring layer gw as seen from the Z-axis.

As illustrated in FIG. 3, each electrostatic protection element group 5 mainly comprises a substantially rectangular parallelepiped varistor matrix 21 and a first terminal 3a, a second terminal 3b, a third terminal 3c, a fourth terminal 3d, a fifth terminal 3e, and a ground terminal 3g which are disposed at outer surfaces of the varistor matrix 21. As the outer surfaces, the varistor matrix 21 has first and second main faces S1, S2 opposing each other along the Z-axis. The first and second main faces S1, S2 extend along XY planes. The first, second, and fifth terminals 3a, 3b, 3e, which are separated from each other along the Y-axis, are exposed at the first main face S1. The third, fourth, and ground terminals 3c, 3d, 3g, which are separated from each other along the Y-axis, are exposed at the second main face S2. The first, second, third, fourth, fifth, and ground terminals 3a, 3b, 3c, 3d, 3e, 3g, which are electrically conductive, contain an electrically conductive material such as Pd, Ag, or an Ag—Pd alloy, for example.

As illustrated in FIG. 3, the varistor matrix 21 is a multilayer body in which a plurality of varistor layers 23 having a current-voltage nonlinear resistance characteristic are laminated. The plurality of varistor layers 23, extending along respective XY planes, are laminated along the Z-axis. The plurality of varistor layers 23 are molded integrally. In this embodiment, each varistor layer 23 is a semiconductor ceramic layer, and the varistor layer 21 is a ceramic matrix constructed by laminating a plurality of such semiconductor ceramic layers.

The varistor layer 23 contains ZnO (zinc oxide) as a main ingredient and at least one kind selected from elemental metals such as rare-earth metal elements, Co, group IIIb elements (B, Al, Ga, and In), Si, Cr, Mo, alkali metal elements (K, Rb, and Cs), and alkaline earth metal elements (Mg, Ca, Sr, and Ba) and their oxides as a sub-ingredient. In this embodiment, the varistor layer 23 contains Pr, Co, Cr, Ca, Si, K, Al, and the like as sub-ingredients. Co and Pr serve as materials for effectively exhibiting the current-voltage nonlinear resistance characteristic. Though not restricted in particular, the ZnO content in the varistor layer 23 is preferably at least 69.0 atomic % but not more than 99.8 atomic % when the total amount of materials for the varistor layer 23 is taken as 100 atomic %.

As illustrated in FIG. 3, the electrostatic protection element group 5 has two first inner electrodes 25, 26, two second inner electrodes 27, 28, a third inner electrode 29, a fourth inner electrode 31, a first through-hole conductor 33, a second through-hole conductor 35, a third through-hole conductor 37, and a fourth through-hole conductor 39 within the varistor matrix 21.

The two first inner electrodes 25, 26, two second inner electrodes 27, 28, third inner electrode 29, and fourth inner electrode 31 extend along respective KY planes with their thickness oriented in the Z-axis. The third inner electrode 29, first inner electrode 25, second inner electrode 27, first inner electrode 26, second inner electrode 28, and fourth inner electrode 31 are disposed in this order while being separated from each other along the Z-axis in the direction from its negative side to positive side. Specifically, the first inner electrode 25 opposes the third inner electrode 29 and second inner electrode 27 through the varistor layers 23. The first inner electrode 26 opposes the second inner electrodes 27, 28 through the varistor layers 23. The second inner electrode 28 opposes the fourth inner electrode 31 through the varistor layer 23.

The two inner electrodes 25, 26, two second inner electrodes 27, 28, third inner electrode 29, and fourth inner electrode 31, which are electrically conductive, contain an electrically conductive material such as Pd, Ag, or an Ag—Pd alloy, for example. The first, second, third, and fourth through-hole conductors 33, 35, 37, and 39, which are electrically conductive, contain an electrically conductive material such as at least one kind of metals selected from the group consisting of Pd, Ag, Cu, W, Mo, Sn, and Ni or an alloy containing at least one kind of such metals, for example. These inner electrodes and through-hole conductors can be constructed as sintered bodies of an electrically conductive paste containing the above-mentioned conductive material, for example.

The first through-hole conductor 33 extends along the Z-axis and is connected to the first and third terminals 3a, 3c physically and electrically. Each of the two first inner electrodes 25, 26 is connected to the first through-hole conductor 33 physically and electrically. As a consequence, the two first inner electrodes 25, 26 are electrically connected to the first and third terminals 3a, 3c.

The second through-hole conductor 35 extends along the Z-axis and is connected to the second and fourth terminals 3b, 3d physically and electrically. Each of the two second inner electrodes 27, 28 is connected to the second through-hole conductor 35 physically and electrically. As a consequence, the two second inner electrodes 27, 28 are electrically connected to the second and fourth terminals 3b, 3d.

The third through-hole conductor 37 extends along the Z-axis and is connected to the ground terminal 3g and the third inner electrode 29 physically and electrically. As a consequence, the ground terminal 3g and the third inner electrode 29 are electrically connected to each other.

The fourth through-hole conductor 39 extends along the Z-axis and is connected to the fifth terminal 3e and the fourth inner electrode 31 physically and electrically. As a consequence, the fifth terminal 3e and the fourth inner electrode 31 are electrically connected to each other.

Each electronic element 2 is disposed on an insulating layer 41 made of a material such as a polyimide resin, glass, or ceramics on the main face S1. The insulating layer 41 has openings on the first and second terminals 3a, 3b, respectively. A first electrode 43 made of an electrically conductive material such as Au, Ag, Al, or Cu is disposed on the first terminal 3a. The first electrode 43 is connected to the first terminal 3a physically and electrically through its corresponding opening of the insulating layer 41. A second electrode 45 made of an electrically conductive material such as Au, Ag, Al, or Cu is disposed on the second terminal 3b. The second electrode 45 is connected to the second terminal 3b physically and electrically through its corresponding opening of the insulating layer 41. The first electrode 43, electronic element 2, and second electrode 45 are separated from each other along the Y-axis.

As illustrated in FIGS. 2 and 3, the first electrode 43 and the input terminal 2a of the electronic element 2 are electrically connected to each other. Specifically, two terminals of a wire member 49 made of an electrically conductive material such as Au or Al are connected to the first electrode 43 and the input terminal 2a through bumps 51, 53, each made of an electrically conductive material such as Au or Al, respectively.

The second electrode 45 and the output terminal 2b of the electronic element 2 are electrically connected to each other. Specifically, two terminals of a wire member 55 made of an electrically conductive material such as Au or Al are connected to the second electrode 45 and the output terminal 2b through bumps 57, 59, each made of an electrically conductive material such as Au or Al, respectively.

The intermediate wiring layers 15 and the ground wiring layer gw, each of which is in contact with the second main face 52, are separated from each other along the Y-axis. The third terminal 3c is connected to one intermediate wiring layer 15 physically and electrically, while the fourth terminal 3d is connected to the other intermediate wiring layer 15 physically and electrically. However, in the plurality of electrostatic protection element groups 5, the third terminal 3c of the electrostatic protection element group 5u is connected to the input-terminal-side wiring layer 13 physically and electrically, while the third terminal 3c of the electrostatic protection element group 5d is connected to the output-terminal-side wiring layer 17 physically and electrically. Each intermediate wiring layer 15 electrically connects the fourth terminal 3d of the electrostatic protection element group 5 adjacent thereto on the negative side of the Y-axis and the third terminal 3c of the electrostatic protection element group 5 adjacent thereto on the positive side of the Y-axis to each other.

In this embodiment, the fifth terminal 3e, fourth through-hole conductor 39, and fourth inner electrode 31 have no electrical roles but are disposed in order to improve the symmetry in the inner structure of the varistor matrix 21, specifically in the symmetry between the positive and negative sides of the Z-axis concerning the structures of terminals, through-hole conductors, and inner electrodes within the varistor matrix 21. For example, this can inhibit the varistor matrix 21 from warping when formed by burying an electrically conductive paste to become the inner electrodes and through-hole conductors into a green sheet to become the varistor matrix 21 and firing the conductive paste and the green sheet at the same time. The electrostatic protection element group 5 may be free of any or all of the fifth terminal 3e, fourth through-hole conductor 39, and fourth inner electrode 31.

According to the structures mentioned above, the electrostatic protection device 3 and the plurality of electronic elements 2 in the electronic apparatus 1A have the circuit structure illustrated in FIG. 1. The first through-hole conductor 33, the second through-hole conductor 35, two first inner electrodes 25, 26, two second inner electrodes 27, 28, the varistor layer 23 between the first and second inner electrodes 25, 27, the varistor layer 23 between the second and first inner electrodes 27, 26, and the varistor layer 23 between the first and second inner electrodes 26, 28 constitute the first electrostatic protection element 6 (see FIG. 1). The first through-hole conductor 33, first inner electrode 25, and third inner electrode 29 constitute the second electrostatic protection element 7 (see FIG. 1).

In thus constructed electrostatic protection device 3 in accordance with this embodiment, static electricity fed into the input terminal 2a of any electronic element 2 flows into not only the first electrostatic protection element 6 electrically connected in parallel thereto, but also the second electrostatic protection element 7 connected between the input terminal 2a of the electronic element 2 and the ground terminal 3g (see FIG. 1). This improves the electrostatic discharge withstand voltage more than in the case where the electrostatic protection device is constructed by the first electrostatic protection elements 6 alone.

In the electrostatic protection device 3 in accordance with this embodiment, the static electricity flowing into the second electrostatic protection element 7 connected to one electronic element 2 leads to the ground G, whereby the part of static electricity directed to another electronic element 2 adjacent to the former electronic element can be reduced (see FIG. 1). Therefore, even when the electrostatic discharge withstand voltage varies among a plurality of electronic elements 2 connected in series, the influence of the electronic element 2 having the lowest electrostatic discharge withstand voltage upon the overall electrostatic discharge withstand voltage decreases. This can inhibit the electronic element 2 having the lowest electrostatic discharge withstand voltage from lowering the overall electrostatic discharge withstand voltage.

Part or whole of the static electricity applied to the input terminals 2a of the electronic elements 2 in the intermediate part (the electronic elements 2 other than the electronic elements 2u, 2d on the most negative and positive sides of the Y-axis in the plurality of electronic elements 2) is guided through the second electrostatic protection elements 7 to the ground G (see FIG. 1). Therefore, in the static electricity applied to the input terminals 2a of the electronic elements 2 in the intermediate part, the part directed to other electronic elements 2 decreases, thereby improving the electrostatic discharge withstand voltage for the static electricity applied to the input terminals 2a of the electronic elements 2 in the intermediate part.

As a result of the foregoing, the electrostatic protection device 3 in accordance with this embodiment can fully improve the electrostatic discharge withstand voltage of a plurality of electronic elements 2 electrically connected in series.

The electronic apparatus 1A in accordance with the present invention comprises a plurality of input terminals 2a electrically connected in series and the electrostatic protection device 3 mentioned above. This yields the electronic apparatus 1A having a high electrostatic discharge withstand voltage.

### Second Embodiment

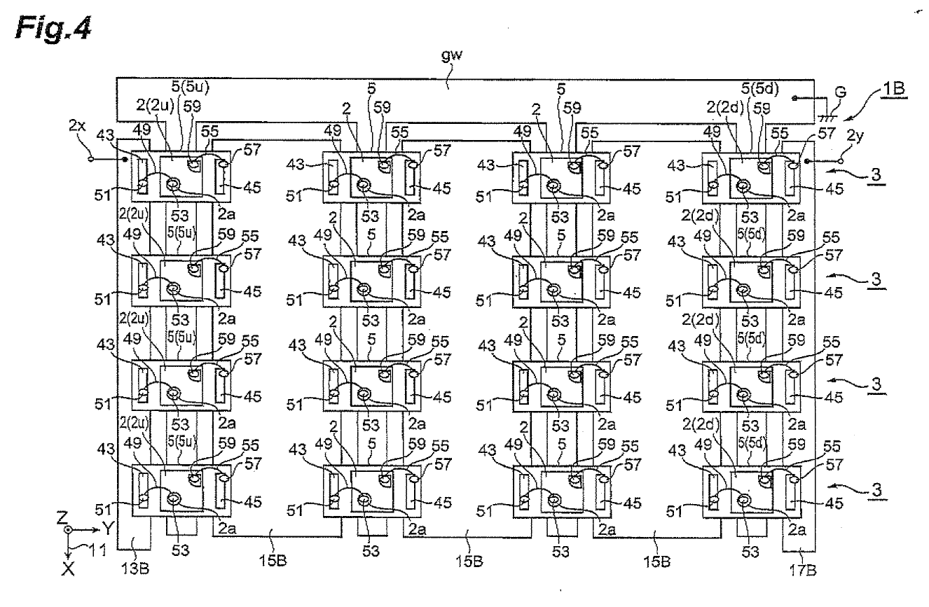

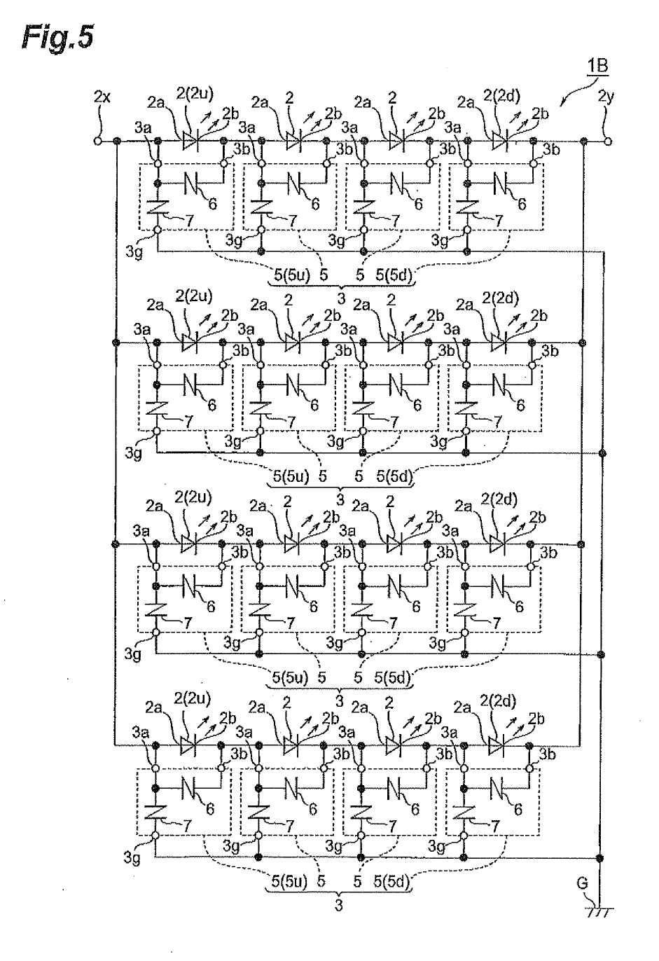

The electrostatic protection device in accordance with the second embodiment and an electronic apparatus equipped therewith will now be explained. In the explanation of the drawings, constituents identical to those in the first embodiment may be referred to with the same signs, so as to omit their overlapping descriptions. FIG. 4 is a plan view illustrating the structure of the electronic apparatus in accordance with this embodiment, while FIG. 5 is a diagram illustrating the circuit structure of the electronic apparatus in accordance with this embodiment.

As illustrated in FIGS. 4 and 5, the electronic apparatus 1B in accordance with this embodiment differs from the electronic apparatus 1A in accordance with the first embodiment in that it comprises four electrostatic protection devices 3 and in terms of structures of its input-terminal-side wiring layer, intermediate wiring layers, and output-terminal-side wiring layer.

The electronic apparatus 1B in accordance with this embodiment is equipped with the four electrostatic protection devices 3 separated from each other along the X-axis.

In a plurality of electrostatic protection element groups 5 in each electrostatic protection device 3, the electrostatic protection element group 5u located on the most negative side of the Y-axis is disposed on an input-terminal-side wiring layer 13B, a ground wiring layer gw, and an intermediate wiring layer 15B as seen from the Z-axis. The input-terminal-side wiring layer 13B is electrically connected to an input terminal 2x. In the plurality of electrostatic protection element groups 5 in each electrostatic protection device 3, the electrostatic protection element group 5d located on the most positive side of the Y-axis is disposed on an intermediate wiring layer 15B, the ground wiring layer gw, and an output-terminal-side wiring layer 17B as seen from the Z-axis. The output-terminal-side wiring layer 17B is electrically connected to an output terminal 2y. In the plurality of electrostatic protection element groups 5 in each electrostatic protection device 3, the electrostatic protection element groups 5 other than the electrostatic protection element groups 5u, 5d are each disposed on two intermediate layers 15B and the ground wiring layer gw as seen from the Z-axis.

The input-terminal-side wiring layer 13B in this embodiment electrically connects together third terminals 3c (see FIG. 3) of the four electrostatic protection element groups 5u located on the most negative side of the Y-axis in the plurality of electrostatic protection element groups 5 in the electrostatic protection devices 3.

Each of the intermediate wiring layers 15B in this embodiment electrically connects four fourth terminals 3d (see FIG. 3) of four electrostatic protection element groups 5 adjacent thereto on the negative side of the Y-axis to four third terminals 3c (see FIG. 3) of four electrostatic protection element groups 5 adjacent thereto on the positive side of the Y-axis.

The output-terminal-side wiring layer 17B in this embodiment electrically connects together fourth terminals 3d (see FIG. 3) of the four electrostatic protection element groups 5d located on the most positive side of the Y-axis in the plurality of electrostatic protection element groups 5 in the electrostatic protection devices 3.

Thus constructed electrostatic protection device 3 in accordance with this embodiment can fully improve the electrostatic discharge withstand voltage of a plurality of electronic elements 2 electrically connected in series because of the same reason as with the electrostatic protection device 3 in accordance with the first embodiment.

Thus constructed electronic apparatus 1B in accordance with this embodiment has a high electrostatic discharge withstand voltage because of the same reason as with the electronic apparatus 1A in accordance with the first embodiment.

### Third Embodiment

The electrostatic protection device in accordance with the third embodiment and an electronic apparatus equipped therewith will now be explained. In the explanation of the drawings, constituents identical to those in the first and second embodiments may be referred to with the same signs, so as to omit their overlapping descriptions.

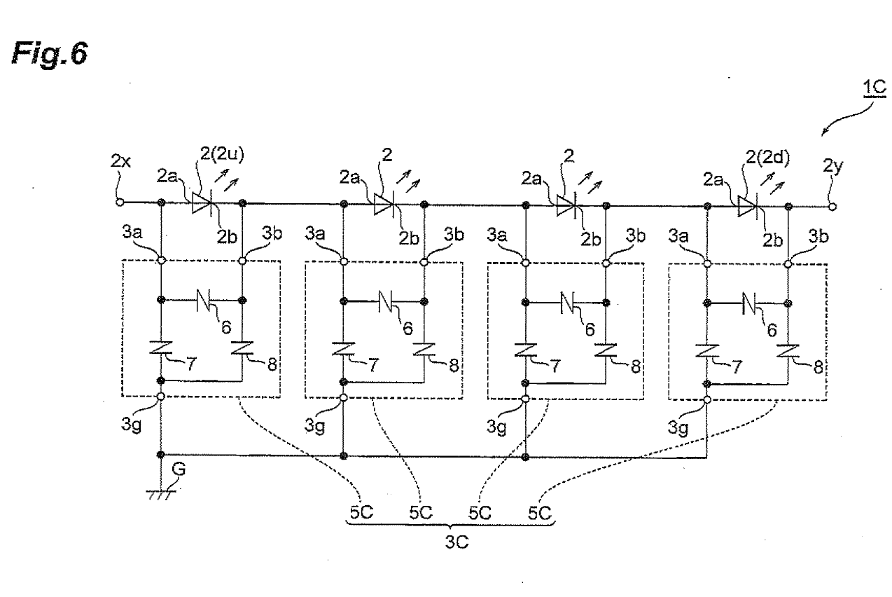

FIG. 6 is a diagram illustrating the circuit structure of the electrostatic protection device in accordance with the third embodiment and the electronic apparatus equipped therewith.

As illustrated in FIG. 6, the electronic apparatus 1C and electrostatic protection device 3C in accordance with this embodiment differ from the electronic apparatus 1A and electrostatic protection device 3 in accordance with the first embodiment (see FIG. 1) in terms of the structure of electrostatic protection element groups. Specifically, a plurality of electrostatic protection element groups 5C in this embodiment further have respective third electrostatic protection elements 8. Hence, each of the plurality of electrostatic protection element groups 5C in this embodiment has first, second, and third electrostatic protection elements 6, 7, 8. The electrostatic protection device 3C in accordance with this embodiment comprises a plurality of such electrostatic protection element groups 5C.

The third electrostatic protection elements 8 are elements similar to the first and second electrostatic protection elements 6, 7. That is, the third electrostatic protection elements 8 have a current-voltage nonlinear resistance characteristic. Specifically, the third electrostatic protection elements 8 have such a characteristic that the resistance value decreases as the applied voltage increases within a certain applied voltage range.

As illustrated in FIG. 6, each of the third electrostatic protection elements 8 is a varistor element in this embodiment. As the varistor element in this embodiment, a ceramic varistor or gap varistor can be used, for example.

The third electrostatic protection elements 8 may also be other elements having a current-voltage nonlinear resistance characteristic such as Zener diodes.

As illustrated in FIG. 6, each third electrostatic protection element 8 is electrically connected between the output terminal 2b of its corresponding electronic element 2 and the ground G. Specifically, each third electrostatic protection element 8 is electrically connected between the second and ground terminals 3b, 3g of its corresponding electrostatic protection element group 5C.

Thus constructed electrostatic protection device 3C in accordance with this embodiment can fully improve the electrostatic discharge withstand voltage of a plurality of electronic elements 2 electrically connected in series because of the same reason as with the electrostatic protection device 3 in accordance with the first embodiment. Thus constructed electronic apparatus 1C in accordance with this embodiment has a high electrostatic discharge withstand voltage because of the same reason as with the electronic apparatus 1A in accordance with the first embodiment.

As illustrated in FIG. 6, thus constructed electrostatic protection device 3C in accordance with this embodiment further comprises a plurality of third electrostatic protection elements 8 having a current-voltage nonlinear resistance characteristic, while the plurality of third electrostatic protection elements 8 are electrically connected between the respective output terminals 2b and ground terminals 3g of a plurality of electronic elements 2.

This allows the third electrostatic protection elements 8 to guide part or whole of the static electricity applied to the output terminals 2b of the electronic elements 2 to the ground G. Therefore, the electrostatic discharge withstand voltage of the plurality of electronic elements 2 electrically connected in series further improves.

### EXAMPLES

Using electronic apparatus of examples and comparative examples, advantageous effects of the present invention will now be explained.

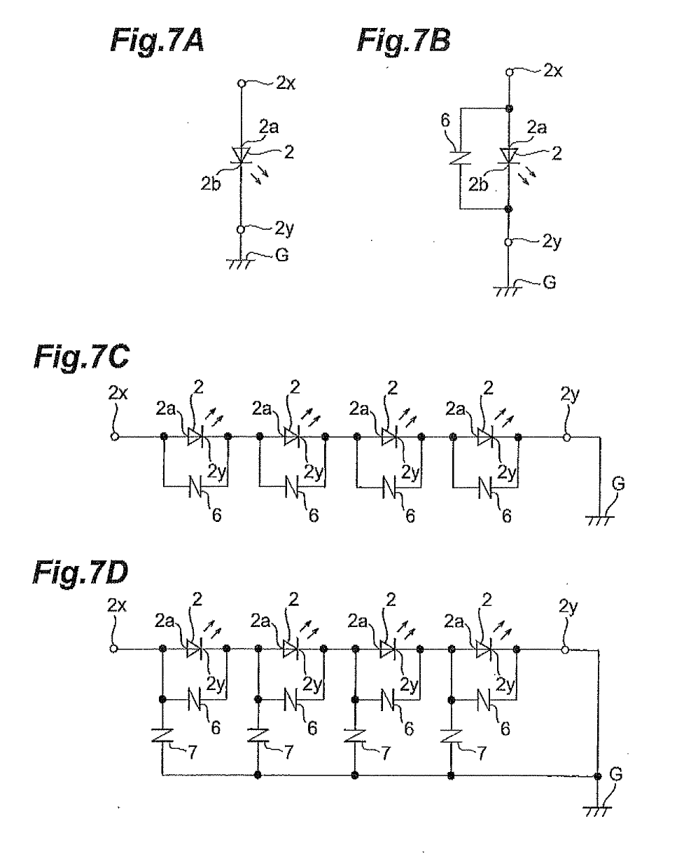

FIGS. 7A, 7B, and 7C are diagrams illustrating the circuit structures of electronic apparatus in accordance with Comparative Examples 1, 2, and 3, respectively, while FIG. 7D is a diagram illustrating the circuit structure of the electronic apparatus in accordance with Example 1.

Comparative Example 1 illustrated in FIG. 7A has only one electronic element 2, its input terminal 2x is electrically connected to the input terminal 2a of the electronic element 2, and its output terminal 2y is electrically connected to the output terminal 2b of the electronic element 2 and the ground G. Comparative Example 2 illustrated in FIG. 7B has one electronic element 2 and a first electrostatic protection element 6 electrically connected in parallel to the electronic element 2. Its input terminal 2x is electrically connected to the input terminal 2a of the electronic element 2, while its output terminal 2y is electrically connected to the output terminal 2b of the electronic element 2 and the ground G. Comparative Example 3 illustrated in FIG. 7C has four electronic elements 2 electrically connected in series and four first electrostatic protection elements 6 electrically connected in parallel to the respective electronic elements 2. Its input terminal 2x is electrically connected to the input terminal 2a of the electronic element 2 located closest to one end in the four electronic elements 2, while its output terminal 2y is electrically connected to the output terminal 2b of the electronic element 2 located closest to the other end in the four electronic elements 2 and the ground G.

Example 1 illustrated in FIG. 7D has four electronic elements 2 electrically connected in series, four first electrostatic protection elements 6 electrically connected in parallel to the respective electronic elements 2, and four second electrostatic protection devices 7 electrically connected between the respective input terminals 2a of the four electronic elements 2 and the ground G. Its input terminal 2x is electrically connected to the input terminal 2a of the electronic element 2 located closest to one end in the four electronic elements 2, while its output terminal 2y is electrically connected to the output terminal 2b of the electronic element 2 located closest to the other end in the four electronic elements 2 and the ground G.

The same LED elements were used as the electronic elements 2 in Comparative Examples 1 to 3 and Example 1. As the first electrostatic protection elements 6 in Comparative Examples 2 and 3 and Example 1, varistor elements each exhibiting a varistor voltage V_{1mA} of 12 V and a capacitance of 350 pF at 1 kHz, 1 Vᵣₘₛ were used. As the second electrostatic protection elements 7 in Example 1, varistor elements each exhibiting a varistor voltage V_{1mA} of 27 V and a capacitance of 40 pF at 1 kHz, 1 Vᵣₘₛ were used. One electronic apparatus of Comparative Example 1, three electronic apparatus of Comparative Example 2, three electronic apparatus of Comparative Example 3, and one electronic apparatus of Example 1 were produced.

Thus constructed electronic apparatus of Comparative Examples 1 to 3 and Example 1 were subjected to a test in conformity with IEC61000-4-2. Specifically, the output voltage level of a testing apparatus was changed, so as to apply ESD (electrostatic discharge) between the input and output terminals 2x, 2y of each of the electronic apparatus in accordance with Comparative Examples 1 to 3 and Example 1, thereby finding output voltage levels of the testing apparatus at which the electronic elements 2, which were LED elements, were destroyed. It was determined that the electronic elements 2 were destroyed when their forward voltage decreased by 10% or more in the case where a forward current at 0.1 mA was caused to flow therethrough.

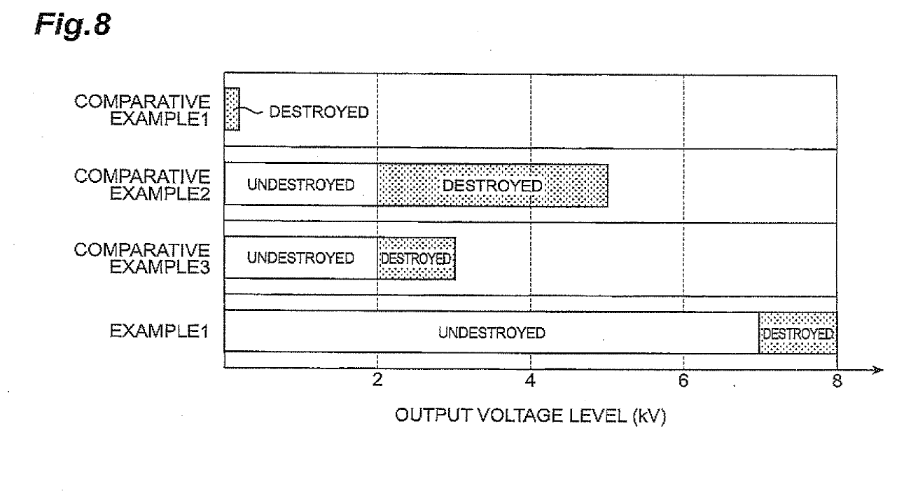

FIG. 8 is a graph illustrating output voltage levels of the testing apparatus at which LED elements in the respective electronic apparatus in accordance with Comparative Examples 1 to 3 and Example 1 were destroyed. In the electronic apparatus of Comparative Example 1, the LED element was destroyed at an output voltage of 0.2 kV or lower. In the electronic apparatus of Comparative Example 2, the LED elements were destroyed at an output voltage of 2 to 5 kV. In the electronic apparatus of Comparative Example 3, the LED elements were destroyed at an output voltage of 2 to 3 kV. In the electronic apparatus of Example 1, the LED elements were destroyed at an output voltage of 7 to 8 kV.

As a result, Example 1 was found to exhibit an electrostatic discharge withstand voltage much higher than those of Comparative Examples 1 to 3.

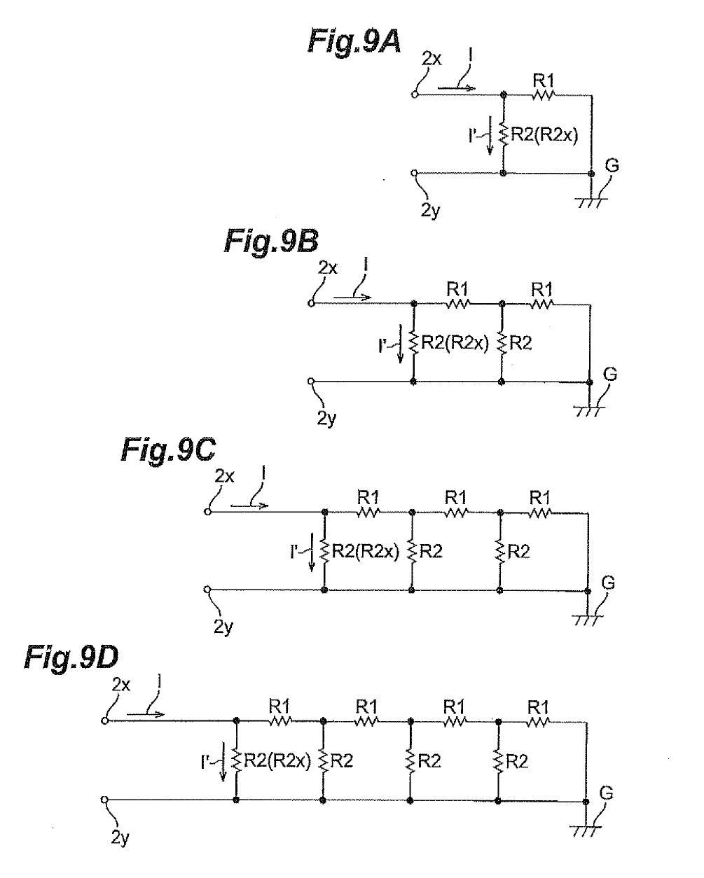

Next, reasons why the electrostatic discharge withstand voltage had increased in Example 1 were studied. While Example 1 can be regarded as a circuit in which four sets each composed of an electronic element 2, a first electrostatic protection element 6, and a second electrostatic protection element 7 are combined together, the electrostatic discharge withstand voltage was examined in each of cases where the number of the sets was 1, 2, 3, and 4 (Example 1), respectively. FIGS. 9A, 9B, 9C, and 9D are diagrams illustrating structures of circuits of electronic apparatus in the cases where the number of the sets is 1, 2, 3, and 4 (i.e., the cases where the electronic element 2, first electrostatic protection element 6, and second electrostatic protection element 7 are provided by 1, 2, 3, and 4 each), respectively.

In this study, the circuit structures in the above-mentioned four cases were simplified as follows. That is, supposing a case where static electricity was applied between the input and output terminals 2x, 2y, the first and second electrostatic protection elements 6, 7 were assumed to be resistances R1, R2 at 1Ω and 4Ω, respectively, as illustrated in FIGS. 9A, 9B, 9C, and 9D. The resistance value of the electronic element 2, which was greater than the resistances R1, R2, was assumed to be infinity. Supposing a case where a current I at 7.5 A flowed between the input and output terminals 2x, 2y, the resistance value in the whole circuit and the value of a current I′ flowing through the resistance R2x closest to the input terminal 2x in the resistances R2 in this case were calculated, tinder some circumstances, the resistance value of the electronic element 2 may be on the order of several times that of the resistance value of the resistances R1, R2 even when static electricity is applied between the input and output terminals 2x, 2y. When the resistance value of the electronic element 2 is assumed to be infinity in such a case, errors may increase in results of the following calculation. Therefore, the following results of study are not always qualitative but may be quantitative.

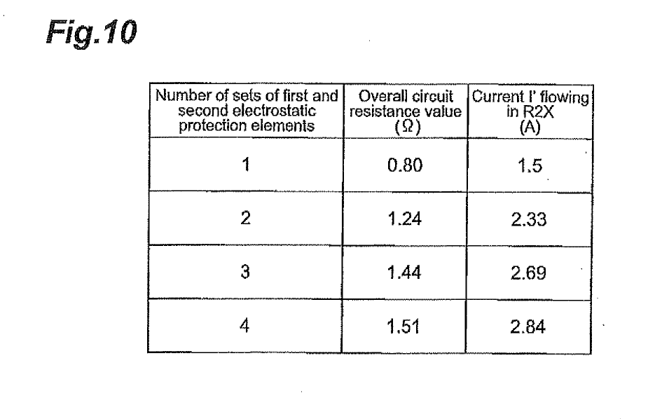

FIG. 10 is a chart listing overall resistance values of circuits and calculated values of the current I′ flowing through the resistance R2x in the four circuits of FIGS. 9A, 9B, 9C, and 9D. As shown in FIG. 10, the overall resistance value of a circuit increased as the number of first and second electrostatic protection elements 6, 7 became greater. Also, the value of the current I′ flowing through the resistance R2x closest to the input terminal 2x increased as the number of first and second electrostatic protection elements 6, 7 became greater. According to these results, one of reasons why Example 1 has a high electrostatic discharge withstand voltage has been found to lie in, that the resistance R2x improves its clamping characteristic (characteristic of letting static electricity escape to the ground side) at the time when the static electricity flows between the input and output terminals 2x, 2y as the number of sets each composed of the electronic element 2, first electrostatic protection element 6, and second electrostatic protection element 7 constructed as mentioned above becomes greater. As for reasons why the present invention is effective in improving the electrostatic discharge withstand voltage, the above-mentioned study takes notice of the clamping characteristic. However, the clamping characteristic is considered to be just one of factors causing the present invention to exhibit the effects mentioned above. Hence, there are cases where the present invention yields the above-mentioned effects according to other factors in addition to the clamping characteristic.

What is claimed is:

1. An electrostatic protection device for protecting a plurality of electronic elements electrically connected in series against static electricity, the device comprising:
a plurality of first electrostatic protection elements having a current-voltage nonlinear resistance characteristic;
a plurality of second electrostatic protection elements having a current-voltage nonlinear resistance characteristic; and
a ground terminal for electrically connecting with a ground;
wherein the plurality of first electrostatic protection elements are electrically connected in parallel to the respective electronic elements; and
wherein the plurality of second electrostatic protection elements are electrically connected between input terminals of the respective electronic elements and the ground terminal.

2. An electrostatic protection device according to claim 1, further comprising a plurality of third electrostatic protection elements having a current-voltage nonlinear resistance characteristic;
wherein the plurality of third electrostatic protection elements are electrically connected between output terminals of the respective electronic elements and the ground terminal.

3. An electrostatic protection device according to claim 1, wherein each of the plurality of first electrostatic protection elements and plurality of second electrostatic protection elements is a varistor element.

4. An electrostatic protection device according to claim 2, wherein each of the plurality of third electrostatic protection elements is a varistor element.

5. An electronic apparatus comprising:
a plurality of electronic elements electrically connected in series and
the electrostatic protection device according to claim 1.
